(19) United States
(12) Patent Application Publication
(10) Pub. No.: US 2024/0013295 A1
(43) Pub. Date: Jan. 11, 2024

(54) EXPLAINING ADVERSE ACTIONS IN CREDIT DECISIONS USING SHAPLEY DECOMPOSITION

(71) Applicant: Wells Fargo Bank, N.A., San Francisco, CA (US)

(72) Inventors: Vijayan Nair, Matthews, NC (US); Linwei Hu, Charlotte, NC (US); Jie Chen, Fremont, CA (US); Agus Sudjianto, Charlotte, NC (US); Tianshu Feng, Keswick, VA (US); Zhanyang Zhang, Charlotte, NC (US)

(21) Appl. No.: 18/336,752

(22) Filed: Jun. 16, 2023

Related U.S. Application Data
(60) Provisional application No. 63/367,701, filed on Jul. 5, 2022.

(51) Int. Cl. G06Q 40/03

(52) U.S. Cl. CPC G06Q 40/03

(57) ABSTRACT

Systems, apparatuses, methods, and computer program products are disclosed for generating a predictive contribution report for an attribute using machine learning techniques. An example method includes generating an entity score for an entity using a predictive analysis machine learning model. The method further includes, in an instance the entity score fails to satisfy a determination decision threshold, selecting a reference entity from a plurality of candidate reference entities and determining a plurality of per-candidate feature contribution scores using a predictive analysis machine learning model. The method further includes generating a predictive contribution report, where the predictive contribution report includes an indication that the entity does not satisfy the determination decision threshold, and an indication of one or more candidate features associated with largest contributions to the entity score.

### CROSS REFERENCE TO RELATED APPLICATIONS

The present application claims the benefit of U.S. Provisional Application No. 63/367,701, filed Jul. 5, 2022, which is hereby incorporated by reference in its entirety.

### BACKGROUND

Various embodiments disclosed herein address technical challenges related to performing predictive data analysis operations, and address efficiency and reliability shortcomings of various existing predictive data analysis solutions, in accordance with at least some of the techniques described herein.

### BRIEF SUMMARY

In general, embodiments disclosed herein provide methods, apparatuses, systems, computing devices, computing entities, and/or the like for performing predictive data analysis operations for predictive contribution determinations for various entities. For example, certain embodiments disclosed herein utilize systems, methods, and computer program products that perform predictive data analysis operations for an entity based on a per-candidate feature contribution score for the entity using a predictive analysis machine learning model.

An example embodiment may be used to explain adverse actions (AA) which may occur when a financial institution declines an application for credit for an entity, which in some situations may be a customer. Adverse actions may include i) refusals to grant credit in the amount or terms requested in the credit application, ii) a termination of an account or unfavorable change in terms of a corresponding account, iii) a refusal to increase the amount of credit available to an applicant, etc. The adverse action may be determined based on a corresponding entity score for the entity, which may be determined by a predictive analysis machine learning model. For example, an adverse action may be determined for an entity when the corresponding entity score fails to satisfy a determination decision threshold. The corresponding entity score may be large, which may indicate a high likelihood of default. The determination decision threshold may control the values or range of values which are acceptable (e.g., not associated with a high probability of default). In the event that an adverse action is determined for the entity, there may be a legal requirement to provide the entity with an explanation of why such an adverse action was determined. The predictive analysis machine learning model may further be configured to generate and/or provide a predictive contribution report which may be indicative of an explanation for reasons the adverse action was determined. The predictive analysis machine learning model may use Baseline Shapley techniques (e.g., Shapley decomposition) to determine the reason(s) for the adverse action, such as by determining a per-candidate feature contribution score for each candidate feature.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 provides an exemplary overview of an architecture that can be used to practice some embodiments of the present innovation.

FIG. 2 provides an example predictive data analysis computing entity in accordance with some embodiments described herein.

FIG. 3 provides an example client computing entity in accordance with some embodiments described herein.

FIG. 4 illustrates an example flowchart for generating a predictive contribution report, in accordance with some example embodiments described herein.

FIG. 5 illustrates an example flowchart for determining a per-candidate feature contribution score for each contribution determination feature, in accordance with some example embodiments described herein.

FIG. 6 illustrates an example selection of a reference feature sub-score, in accordance with some example embodiments described herein.

FIG. 7 illustrates an example decomposition of a reference feature sub-score, in accordance with some example embodiments described herein.

FIG. 8 illustrates an example correlation matrix for candidate features as described in example 1.

FIG. 9 depicts plots showing the variable importance of the candidate features for the second predictive analysis machine learning model with the mono-NN algorithm as described in example 1.

FIG. 10 illustrates one dimensional partial-dependence plots describing one-dimensional input-output relationships as described in example 1.

### DETAILED DESCRIPTION

Some example embodiments will now be described more fully hereinafter with reference to the accompanying figures, in which some, but not necessarily all, embodiments are shown. Because innovations described herein may be embodied in many different forms, the innovation should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

### I. OVERVIEW AND TECHNICAL ADVANTAGES

Various embodiments disclosed herein relate to determining a predictive action to take for an entity based on associated per-candidate feature contribution scores generated for the entity using a predictive analysis machine learning model, thereby also providing interpretability of otherwise black-box outputs generated by the predictive analysis machine learning model. While the use of such machine learning techniques may allow for consideration of a wide range of entity features and associated increased predictive accuracy, such techniques often lack interpretability. For example, financial institutions may use machine learning techniques, either alone or in tandem with manual review, to determine whether to approve a customer's associated credit application. While use of such models aid in the accuracy of these decisions, compliance regulations may dictate that denial decisions be supplemented with reasons for decline, which may be complicated by a lack of insight into the dynamically weighted features of such models.

An example implementation may be used to explain adverse actions (AA) which occur when a financial institution declines an application for credit for an entity (e.g., a customer). Adverse actions may include i) refusals to grant credit in the amount or terms requested in the credit application, ii) a termination of an account or unfavorable change in terms of a corresponding account, iii) a refusal to increase the amount of credit available to an applicant, etc. The adverse action may be determined based on a corresponding entity score for the entity, which may be determined by a predictive analysis machine learning model. For example, an adverse action may be determined for an entity when the corresponding entity score fails to satisfy a determination decision threshold. The corresponding entity score may be large, which may indicate a high likelihood of default. The determination decision threshold may control the values or range of values which are acceptable (e.g., not associated with a high probability of default). In the event that an adverse action is determined for the entity, there may be a legal requirement to provide the entity with an explanation of why such an adverse action was determined. The predictive analysis machine learning model may further be configured to generate and/or provide a predictive contribution report. The predictive contribution report may indicate an explanation of the reasons that the adverse action was determined. The predictive analysis machine learning model may use Baseline Shapley techniques (e.g., Shapley decomposition) to determine the reason(s) for the adverse action, such as by determining a per-candidate feature contribution score for each candidate feature.

To address the above-noted technical challenges, various embodiments disclosed herein describe a predictive analysis machine learning model configured to generate an entity score, as well as a predictive contribution report based on each per-candidate feature contribution score for each candidate feature for an entity. Each candidate feature may be descriptive of a considered parameter used in the predictive analysis machine learning model and its impact to the entity score. Thus, the predictive analysis machine learning model may provide for an accurate entity score determination while also providing for interpretability of the impact of each candidate feature considered by said model.

Various embodiments disclosed herein also address technical challenges for efficient per-candidate feature contribution score determinations in real-time by introducing techniques that enable utilizing an existing reference entity selected based on one or more dynamically customizable reference determination decision thresholds, in part to determine the per-candidate feature contribution score for each candidate feature. By using an existing reference entity, which may satisfy the one or more reference determination decision thresholds, the predictive analysis machine learning model may reduce the computational complexity of runtime operations that may be associated with processing of a non-existent reference entity for use by the predictive analysis machine learning model. Additionally, the one or more dynamically customizable reference determination decision thresholds may be customized to a user, institution, regulatory body, etc. specifications, thereby allowing for controllability with respect to determination of each per-candidate feature contribution score. For example, in some embodiments, it may be advantageous to select a reference entity such that a reference entity score (of the reference entity) is near a maximum reference entity score. Alternatively, in some embodiments, it may be advantageous to select a reference determination decision threshold such that a reference entity with a corresponding reference entity score near the value of the determination decision threshold is selected. In yet another embodiment, it may be advantageous to select a reference determination decision threshold near the value of the determination decision threshold, but with an additional buffer score (e.g., a reference entity score 10%-15% above the determination decision threshold value).

Furthermore, in some embodiments, the predictive analysis machine learning model may determine a pairwise feature correlation score for each pair of candidate features, where, for example, each possible pair of candidate features from the set of candidate features is considered. In the event the pairwise feature correlation score for a pair of candidate features satisfies one or more feature correlation thresholds, the predictive analysis machine learning model may determine the per-candidate feature contribution score for the candidate features together. For example, if candidate features 1 and 5, candidate features 1 and 7, and candidate features 5 and 7 are determined to each have a pairwise feature correlation score which satisfies the one or more feature correlation thresholds, candidate features 1, 5, and 7 may be considered together when determining the per-candidate feature contribution score. As such, correlated candidate features may be considered in aggregate, thereby advantageously allowing for improved computational efficiency of computer-implemented modules that perform operations corresponding to the predictive analysis machine learning model. The predictive analysis machine learning model may therefore generate per-candidate feature contribution scores while reducing the computational complexity of runtime operations, thus resulting in a more time efficient and less computationally resource-intensive method to generate a predictive contribution report for the entity.

Additionally, various embodiments disclosed herein make important technical contributions to improving resource-usage efficiency of post-prediction systems by using generated entity scores to set the number of allowed computing entities used by post-prediction systems, and thus perform operational load balancing for post-prediction systems. For example, a predictive data analysis computing entity may determine entity scores for N entities. Of the N entity scores, M entity scores may satisfy the determination decision threshold while L entity scores may fail to satisfy the determination decision threshold, where the count of M plus L is equivalent to N. As the L entity scores which did not satisfy the determination decision threshold may require increased computational time from the associated predictive data analysis computing entity, it may be advantageous to distribute additional processing requests to predictive data analysis computing entities where the count of entity scores which did not satisfy the determination decision threshold is less than the count L. This may be done by dynamically allocating and de-allocating computing entities to the post-prediction processing operations based on the number of entity scores which satisfy the determination decision threshold.

Thorough analyses on both simulated data and public real data demonstrate both of these results. In addition, as further disclosed herein, it is possible to increase interpretability of a generated entity score for an entity based on the entity score and a selected reference entity.

Although a high-level explanation of the operations of example embodiments has been provided above, specific details regarding the configuration of such example embodiments are provided below.

### II. COMPUTER PROGRAM PRODUCTS, METHODS, AND COMPUTING ENTITIES

Embodiments disclosed herein may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments disclosed herein may also be implemented as methods, apparatuses, systems, computing devices, computing entities, and/or the like. As such, embodiments may take the form of an apparatus, system, computing device, computing entity, and/or the like executing instructions stored on a computer-readable storage medium to perform certain steps or operations. Thus, embodiments disclosed herein may also take the form of an entirely hardware embodiment, an entirely computer program product embodiment, and/or an embodiment that comprises combination of computer program products and hardware performing certain steps or operations.

Example embodiments are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### III. EXAMPLE SYSTEM FRAMEWORK

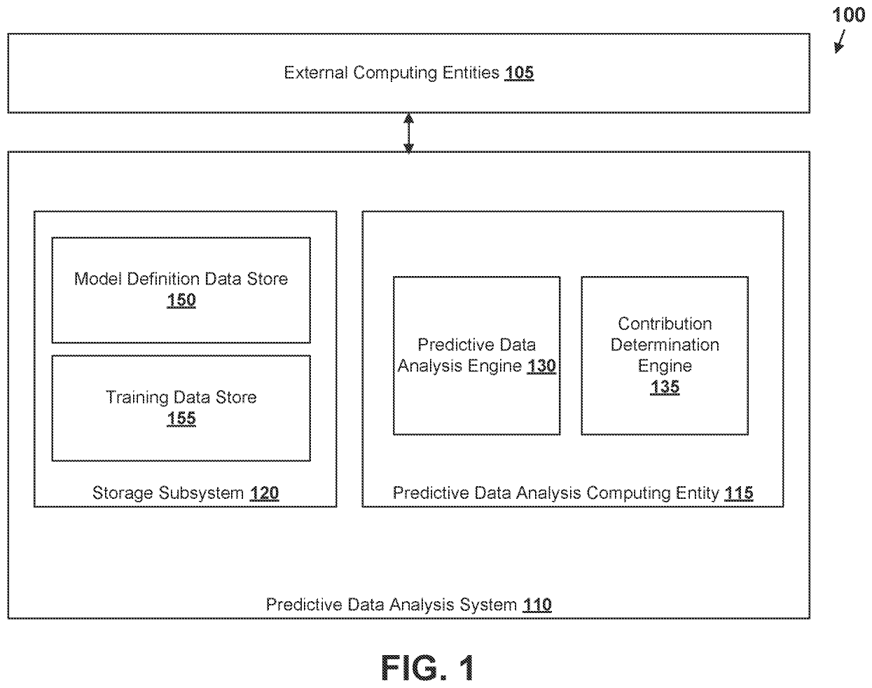

FIG. 1 is a schematic diagram of an example system architecture 100 for performing predictive data analysis operations and for performing one or more prediction-based actions (e.g., generating a predictive contribution report). The system architecture 100 includes a predictive data analysis system 110 comprising a predictive data analysis computing entity 115 configured to generate predictive outputs that can be used to perform one or more prediction-based actions. The predictive data analysis system 110 may communicate with one or more external computing entities 105 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The system architecture 100 includes a storage subsystem 120 configured to store at least a portion of the data utilized by the predictive data analysis system 110. The predictive data analysis computing entity 115 may be in communication with one or more external computing entities 105. The predictive data analysis computing entity 115 may be configured to train a prediction model based at least in part on the training data 155 stored in the storage subsystem 120, store trained prediction models as part of the model definition data store 150 stored in the storage subsystem 120, utilize trained models to generate predictions based at least in part on prediction inputs provided by an external computing entity 105, and perform prediction-based actions based at least in part on the generated predictions. The storage subsystem may be configured to store the model definition data store 150 for one or more predictive analysis models and the training data 155 uses to train one or more predictive analysis models. The predictive data analysis computing entity 115 may be configured to receive requests and/or data from external computing entities 105, process the requests and/or data to generate predictive outputs and provide the predictive outputs to the external computing entities 105. The external computing entity 105 may periodically update/provide raw input data (e.g., data objects describing an entity input data object) to the predictive data analysis system 110.

The storage subsystem 120 may be configured to store at least a portion of the data utilized by the predictive data analysis computing entity 115 to perform predictive data analysis steps/operations and tasks. The storage subsystem 120 may be configured to store at least a portion of operational data and/or operational configuration data including operational instructions and parameters utilized by the predictive data analysis computing entity 115 to perform predictive data analysis steps/operations in response to requests. The storage subsystem 120 may include one or more storage units, such as multiple distributed storage units that are connected through a computer network. Each storage unit in the storage subsystem 120 may store at least one of one or more data assets and/or one or more data about the computed properties of one or more data assets. Moreover, each storage unit in the storage subsystem 120 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The predictive data analysis computing entity 115 includes a predictive data analysis engine 130 and a contribution determination engine 135. The predictive data analysis engine 130 may be configured to perform predictive data analysis based at least in part on an entity input data object. For example, the predictive data analysis engine 130 may be configured to generate one or more entity scores corresponding to one or more entities. The contribution determination engine 135 may be configured to determine each per-candidate feature contribution score in accordance with the model definition data store 150 stored in the storage subsystem 120.

### Example Predictive Data Analysis Computing Entity

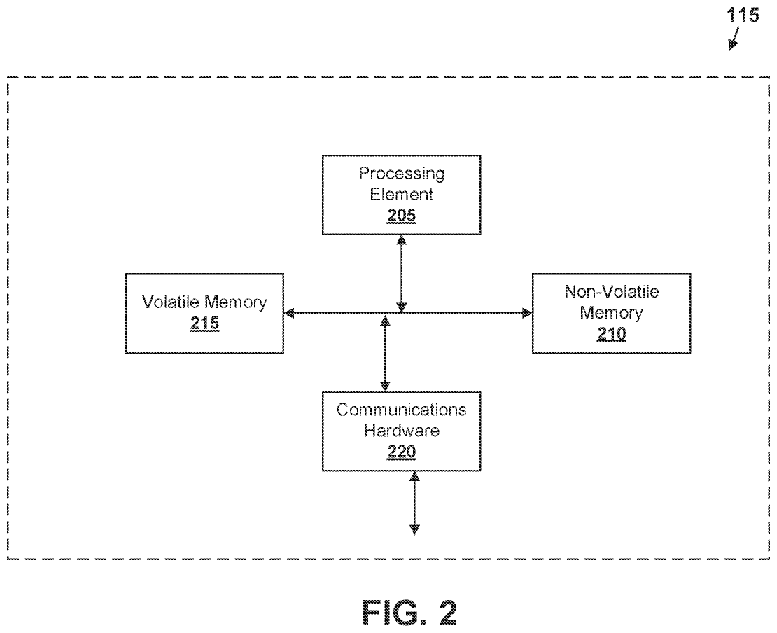

FIG. 2 provides a schematic of a predictive data analysis computing entity 115 according to one example embodiment. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably.

As indicated, in one embodiment, the predictive data analysis computing entity 115 may also include communications hardware 220 for communicating with various computing entities, such as by communicating data, content, information, and/or similar terms used herein interchangeably that can be transmitted, received, operated on, processed, displayed, stored, and/or the like.

The communications hardware 220 may further be configured to provide output to a user and, in some embodiments, to receive an indication of user input. In this regard, the communications hardware 220 may comprise a user interface, such as a display, and may further comprise the components that govern use of the user interface, such as a web browser, mobile application, dedicated client device, or the like. In some embodiments, the communications hardware 220 may include a keyboard, a mouse, a touch screen, touch areas, soft keys, a microphone, a speaker, and/or other input/output mechanisms. The communications hardware 220 may utilize the processing element 205 to control one or more functions of one or more of these user interface elements through software instructions (e.g., application software and/or system software, such as firmware) stored on a memory (e.g., non-volatile memory 210) accessible to the processing element 205.

As shown in FIG. 2, in one embodiment, the predictive data analysis computing entity 115 may include or be in communication with a processing element 205 (also referred to as processors, processing circuitry, and/or similar terms used herein interchangeably) that communicate with other elements within the predictive data analysis computing entity 115 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments disclosed herein when configured accordingly.

In one embodiment, the predictive data analysis computing entity 115 may further include or be in communication with non-volatile media (also referred to as non-volatile storage, memory, memory storage, memory circuitry and/or similar terms used herein interchangeably). In one embodiment, the non-volatile storage or memory may include at least one non-volatile memory 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 115 may further include or be in communication with volatile media (also referred to as volatile storage, memory, memory storage, memory circuitry and/or similar terms used herein interchangeably). In one embodiment, the volatile storage or memory may also include at least one volatile memory 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 115 with the assistance of the processing element 205 and operating system.

As indicated, in one embodiment, the predictive data analysis computing entity 115 may also include a communications hardware 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 115 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 115 may include or be in communication with one or more input elements, such as a keyboard input, a mouse input, a touch screen/display input, motion input, movement input, audio input, pointing device input, joystick input, keypad input, and/or the like. The predictive data analysis computing entity 115 may also include or be in communication with one or more output elements (not shown), such as audio output, video output, screen/display output, motion output, movement output, and/or the like.

### Example External Computing Entity

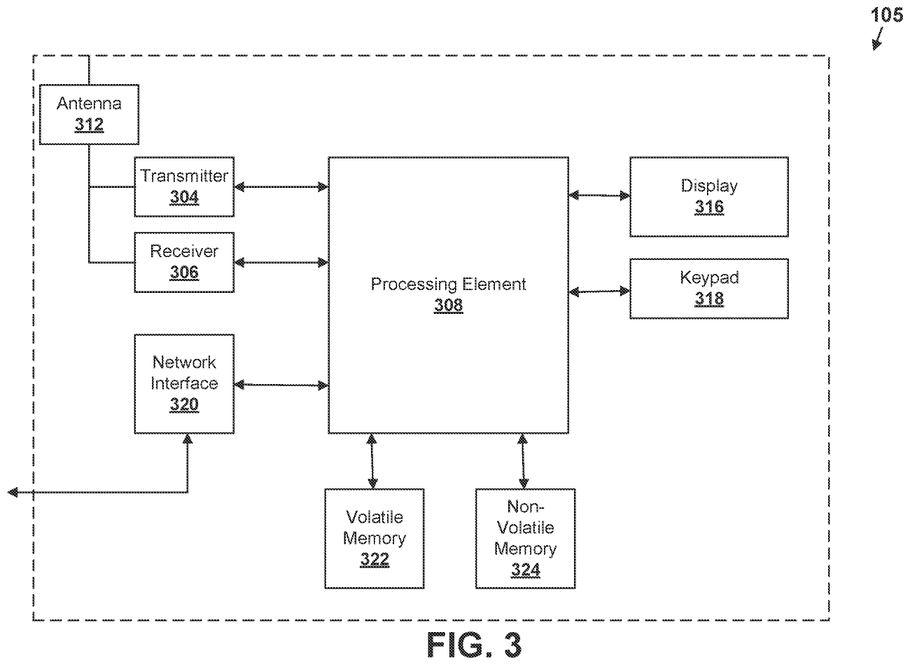

FIG. 3 provides an illustrative schematic representative of an external computing entity 105 that can be used in conjunction with embodiments disclosed herein. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. External computing entities 105 can be operated by various parties. As shown in FIG. 3, the external computing entity 105 can include antennas, transmitters (e.g., radio), receivers (e.g., radio), and a processing element 308 (e.g., CPLDs, microprocessors, multi-core processors, coprocessing entities, ASIPs, microcontrollers, and/or controllers) that provide signals to and receives signals from other computing entities. Similarly, the external computing entity 105 may operate in accordance with multiple wired communication standards and protocols, such as those described above with regard to the predictive data analysis computing entity 115 via a network interface 320.

Via these communication standards and protocols, the external computing entity 105 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 105 can also download changes, add-ons, and updates, for instance, to its firmware, software (e.g., including executable instructions, applications, program modules), and operating system.

The external computing entity 105 may also comprise a user interface (that can include a display coupled to a processing element) and/or a user input interface (coupled to a processing element 308). For example, the user interface may be a user application, browser, user interface, and/or similar words used herein interchangeably executing on and/or accessible via the external computing entity 105 to interact with and/or cause display of information/data from the predictive data analysis computing entity 115, as described herein. The user input interface can comprise any of a number of devices or interfaces allowing the external computing entity 105 to receive data, such as a keypad (hard or soft), a touch display, voice/speech or motion interfaces, or other input device.

The external computing entity 105 can also include volatile storage or memory 322 and/or non-volatile storage or memory 324, which can be embedded and/or may be removable. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 105. As indicated, this may include a user application that is resident on the entity or accessible through a browser or other user interface for communicating with the predictive data analysis computing entity 115 and/or various other computing entities.

In another embodiment, the external computing entity 105 may include one or more components or functionality that are the same or similar to those of the predictive data analysis computing entity 115, as described in greater detail above. As will be recognized, these frameworks and descriptions are provided for exemplary purposes only and are not limiting to the various embodiments.

In various embodiments, the external computing entity 105 may be embodied as an artificial intelligence (AI) computing entity, such as an Amazon Echo, Amazon Echo Dot, Amazon Show, Google Home, and/or the like. Accordingly, the external computing entity 105 may be configured to provide and/or receive information/data from a user via an input/output mechanism, such as a display, a video capture device (e.g., camera), a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### VI. EXAMPLE OPERATIONS

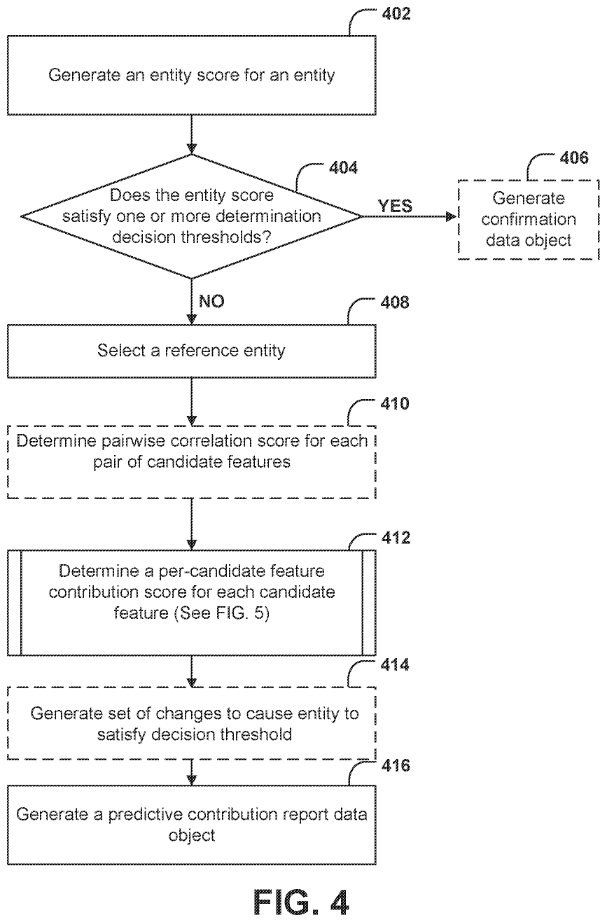

Turning to FIG. 4, an example flowchart is illustrated that contains example operations implemented by various embodiments contemplated herein. The operations illustrated in FIG. 4 may, for example, be performed by an apparatus such as predictive data analysis computing entity 115, which is shown and described in connection with FIG. 1. To perform the operations described below, the predictive data analysis computing entity 115 may utilize one or more of processing element 205, volatile memory 215, non-volatile memory 210, communications hardware 220, other components, and/or any combination thereof. It will be understood that user interaction with the predictive data analysis computing entity 115 may occur directly via communications hardware 220, or may instead be facilitated by a device that in turn interacts with predictive data analysis computing entity 115.

As shown by operation 402, predictive data analysis computing entity 115 includes means, such as processing element 205, communications hardware 220, or the like, for generating an entity score for an entity. In some embodiments, the predictive data analysis computing entity 115 may receive an entity input data object for a respective entity. The entity input data object may also include a requested action. For example, the entity input data object may describe various financial feature values for a particular user (e.g., entity) applying for a credit product, and the requested action may be a prediction of whether the user will default on the credit product. The predictive data analysis computing entity 115 may be configured to process the entity input data object using a predictive analysis machine learning model to generate an entity score for the respective entity. The entity score may be based at least in part on a set of entity feature sub-scores each associated with a respective candidate feature of a plurality of candidate features (e.g., a set of candidate features). The plurality of candidate features may be features used by the predictive analysis machine learning model.

In some embodiments, the predictive analysis machine learning model may refer to an electronically-stored data construct that is configured to describe parameters, hyperparameters, and/or stored operations of a machine learning model that is configured to process an entity input data object and generate an entity score for the entity. An entity input data object may be configured to describe data values for the entity. For example, in some embodiments, an entity input data object may correspond to a credit application for an individual (e.g., an entity). As such, the entity input data object may include pertinent information for the individual such as an address, phone number, social security number, employer identification number, credit references, credit scores, income amount, employment history, debt amount, debt-to-income ratio, etc.

In some embodiments, the predictive analysis machine learning model may be a trained neural network model. In particular, in some embodiments, the predictive analysis machine learning model may be a feedforward neural network (FFNN) model or a monotone neural network (mono-NN) model. The predictive analysis machine learning model may be configured to process the data included within the entity input data object to determine an entity score for the entity. The generated entity score may be output as a vector comprising a numerical value (e.g., binary, decimal, etc.), categorical value (e.g., “approve”, “deny”, etc.), Boolean value (e.g., true, false), and/or the like. In some embodiments, the entity score may be determined based on a reference determination decision threshold, as will be described in further detail below.

At operation 404, the predictive data analysis computing entity 115 includes means, such as processing element 205, or the like, for determining whether the entity score satisfies a determination decision threshold. The predictive data analysis computing entity 115 may be configured to compare the entity score to the determination decision threshold. A determination decision threshold may be dynamically determined based at least in part on a plurality of an analysis of aggregated historical entity scores each associated with a plurality of entities, which may be stored in the storage subsystem 120. The determination decision threshold may be updated periodically, semi-periodically, or when manually requested. As such, the determination decision threshold may be updated in view of recent historical entity data, thereby allowing for increased accuracy for determination of the determination decision threshold to be used with respect to an entity score.

For example, denote p(x) as the entity score (e.g., predicted probability of default) of an entity x (e.g., representing a customer characteristic) with candidate features (x₁, . . . , x_{K}), which may be obtained by fitting a model to historical data. Then denote T as the suitably chosen determination decision threshold. A credit-decision algorithm may approve a future loan application with attribute x* if p(x*)≤τ and decline otherwise. In practice, p(x) may be developed in terms of a link function, such as ƒ(x)=logit[p(x)]. Since the model may be simpler or more interpretable in terms of ƒ(x), example embodiments may be disclosed herein in terms of ƒ(x). However, the same embodiments may be implemented in terms of p(x).

In an instance in which the entity score satisfies the determination decision threshold, the process proceeds to operation 406. At operation 406, the predictive data analysis computing entity 115 includes means, such as processing element 205, or the like, for generating a confirmation data object. The confirmation data object may indicate the entity score associated with the entity satisfies the determination decision threshold. In some embodiments, the confirmation data object may also indicate the entity score associated with the entity. The confirmation data object may be provided to one or more end users via an associated user device. By way of continuing example, an individual who has applied for a credit application, and who is approved for said application (e.g., the associated entity score satisfies the determination decision threshold), may be provided with a confirmation data object indicating that the credit application has been improved. Additionally, the confirmation data object may include supplemental information, such as details regarding next steps, account details, login information, and/or the like.

In an instance in which the entity score does not satisfy the determination decision threshold, the process proceeds to operation 408. In such a situation, by way of continuing example, an individual who has applied for a credit application may be denied for said application (e.g., the associated entity score fails to satisfy the determination threshold). As such, it may be necessary to provide the user (e.g., the individual who applied for a credit application) with an indication of why he/she was denied and optionally, provide other users (e.g., employees associated with the system) with this indication as well. As described above, due to the complexities associated with machine learning models, it may be difficult to ascertain the reason for such a denial. As such, the operations described in operations 408-418 may improve the interpretability of the predictive analysis machine learning model that was used to generate the entity score that, ultimately, led to the outcome of the denial of the credit application. As such, the subsequent operations described below may allow the individual, credit loan officers, regulatory body employees, and the like to understand the reason for the denial.

At operation 408, the predictive data analysis computing entity 115 includes means, such as processing element 205, or the like, for selecting a reference entity. The predictive data analysis computing entity 115 may select the reference entity from a plurality of candidate reference entities, such as those stored in the storage subsystem 120. The reference entity may be selected based at least in part on a set of reference feature sub-scores each associated with a respective candidate feature of a plurality of candidate features. The plurality of candidate features associated with the reference entity may be the same candidate features associated with the entity.

The predictive data analysis computing entity 115 may use the predictive analysis machine learning model to select a reference entity from a plurality of the candidate reference entities based on whether the one or more candidate reference entity scores satisfy one or more reference determination decision thresholds. The one or more dynamically customizable reference determination decision thresholds may be dynamically determined based on one or more rules enabled by a user, institution, regulatory body, etc. specifications. For example, in some embodiments, it may be advantageous to select a reference determination decision threshold such that a reference entity associated with a reference entity score is near a maximum reference entity score (e.g., a greatest reference entity score). Alternatively, in some embodiments, it may be advantageous to select a reference determination decision threshold such that a reference entity score near the value of the determination decision threshold is selected. In yet another embodiment, it may be advantageous to select a reference determination decision threshold near the value of the determination decision threshold but with an additional buffer score (e.g., a reference entity score 10%-15% above the determination decision threshold value).

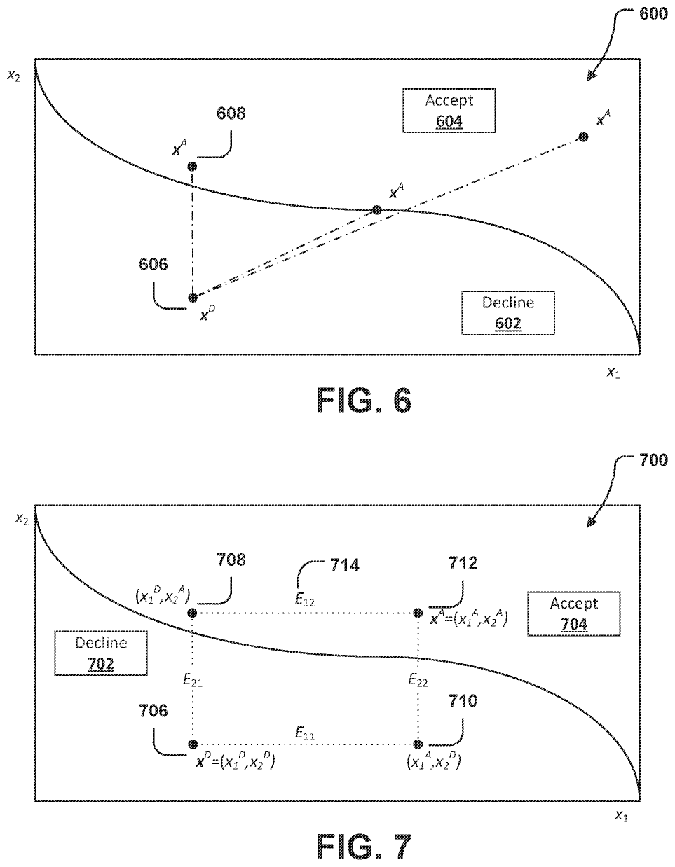

For example, the predictive data analysis computing entity 115 may compare the entity (e.g., loan characteristic) x^{D} with reference entity x^{A}. In various examples, the reference entity x^{A} corresponds to a loan application that has an entity score satisfying the determination decision threshold (e.g., the loan would be approved). FIG. 6 graphically illustrates this comparison by the point 606 x^{D}, with several examples of points 608 x^{A} in feature space 600. The feature space 600 is divided into an accept region 604 (e.g., where p(x*)≤τ), and a decline region 602 (e.g., where p(x*)>τ).

For the following examples, suppose x^{D} represents an entity that does not satisfy a determination decision threshold (which may happen for a declined loan application). Several example methods are disclosed below for selecting a reference feature sub-score that lies within the accept region 604. The chosen method for making this selection may depend on a number of practical considerations. For a first example, reference entity x^{A} may be chosen at high values of the feature sub-scores in the accept region 604, such as values close to a maximum. For a second example, x^{A} may be chosen as the point with the shortest distance from x^{D} to the determination decision threshold boundary (“boundary”). This choice may provide information on the smallest changes needed to move the entity across the boundary to satisfy the determination decision threshold. However, in this example, the determination decision threshold boundary may be estimated from data, and may be subject to inherent variability, and the reference feature may vary with the individual entity and thus may be difficult to explain small variations to multiple entities. For a third example, reference features may be considered that have the shortest distance in a lower-dimensional subspace of the candidate features (e.g., features x₁, . . . x_{K}). The contribution determination engine 135 may select the lower-dimensional subspace based on candidate features that are pre-determined as relevant. The lower-dimensional subspace may have fewer dimensions than the original feature space in which the entity is embedded (e.g. feature space 600). For example, a customer may be interested in a subset of candidate features (xₐ₁, . . . x_{aN}) deemed relevant because the customer may have more direct input to modify the candidate features belonging to the subset. By determining the candidate attribute using the lower-dimensional space defined by the subset of features, a determination may be made that relies only on the features of interest to the customer.

At operation 410, the predictive data analysis computing entity 115 may include means, such as processing element 205, or the like, for determining pairwise feature correlation score for each pair of candidate features. In some embodiments, the predictive data analysis computing entity 115 may receive candidate features that are highly or moderately correlated, which may occur especially for models including a large number of candidate features. The predictive data analysis computing entity 115 may detect that model values of extrapolation entity scores (described in further detail below) may lie outside the envelope where the model makes reliable predictions. In such instances, the correlated candidate features may be treated jointly by deriving new candidate features, where a new candidate feature may be a function of two of the highly correlated candidate features.

At operation 412, the predictive data analysis computing entity 115 includes means, such as processing element 205, or the like, for determining a per-candidate feature contribution score for each candidate feature. In some embodiments, the predictive analysis machine learning model may be configured to process an entity input data object and generate a per-candidate feature contribution score for each candidate feature. The predictive analysis machine learning model may decompose the model (e.g., weighted linear function) used to generate the entity score to generate each per-candidate feature contribution score for each candidate feature. The generated per-candidate feature contribution scores may be output as a vector comprising each per-candidate feature contribution score. Each position in the vector may correspond to a respective candidate feature.

The predictive data analysis computing entity 115 may use the predictive analysis machine learning model to determine each per-candidate contribution score for each candidate feature. The predictive analysis machine learning model may be configured to use Baseline Shapley techniques (e.g., Shapley decomposition) to generate the per-candidate contribution score for each candidate feature. In some embodiments, the predictive analysis machine learning model may be configured to decompose the difference of the model (e.g., weighted linear combination) used to generate the entity score and reference entity to generate a per-candidate contribution score.

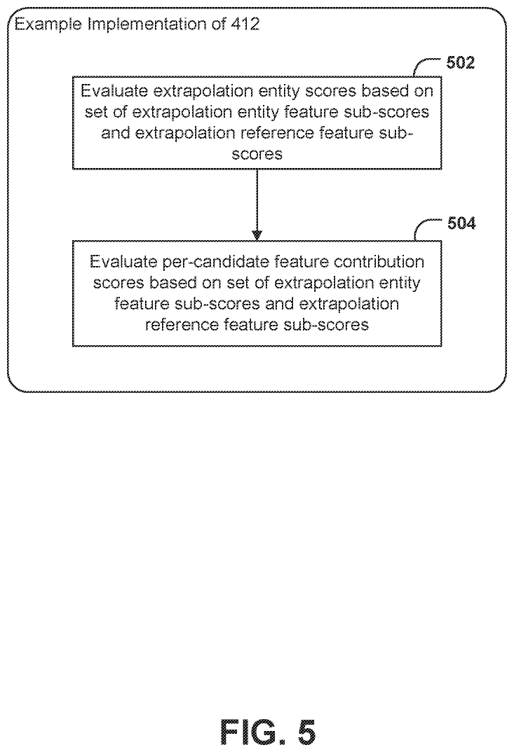

Turning to FIG. 5, a flowchart is shown depicting an example implementation of operation 412, determining a per-candidate feature contribution score for each candidate contribution feature. At operation 502, the predictive data analysis computing entity 115 includes means, such as processing element 205, or the like, for evaluating a set of extrapolation scores based on the reference entity and the entity score. For a motivating example, consider an example linear model with no interactions of the form:

ƒ(x)=b₀+b₁x₁+ . . . +b_{K}xₖ.

The model may be decomposed into per-candidate feature contribution scores for a given reference entity x^{A} according to:

$$[ f ( {x}^{D} ) - f ( {x}^{A} ) ] = {\sum }_{k} {E}_{k} ( {x}^{D} , {x}^{A} )$$

where Eₖ(x^{D}, x^{A}) is the per-candidate feature contribution score of the k^{th} candidate feature to the model. The decomposition of the example linear model is straightforward, with Eₖ=bₖ(xₖ^{D}−xₖ^{A}) for k=1, . . . , K. For simplification purposes, Eₖ(x^{D}, x^{A}) may be denoted simply as Eₖ.

As another example, a two-factor linear model with even simple interactions actions may be represented in the form:

ƒ(x)=b₀+b₁x₁+b₂x₂+b₁₂x₁x₂.

The model may then be decomposed into per-candidate feature contribution score according to:

[ƒ(x^{D})−ƒ(x^{A})]b₁(x₁^{D}−x₁^{A})+b₂(x₂^{D}−x₂^{A})+b_{1,2}(x₁^{D}x₂^{D}−x₂^{A}x₂^{A}).

The last term on the right-hand side of involves both x₁ and x₂ and thus, must be further decomposed and allocated to each separately.

To further appreciate the above two-factor linear model, a general two-factor model with two candidate features is detailed. Consider a function:

ƒ(x)=ƒ(x₁,x₂).

The model may be decomposed into per-candidate feature contribution scores for a given reference entity x^{A} according to:

$$[ f ( {x}^{D} ) - f ( {x}^{A} ) ] = {E}_{11} + {E}_{22} = \frac{1}{2} ( {E}_{11} + {E}_{12} ) + \frac{1}{2} ( {E}_{21} + {E}_{22} ) .$$

Here, E₁₁ may be defined as [ƒ(x₁^{D},x₂^{D})−ƒ(x₁^{A},x₂^{D})], E₁₂ may be defined as [ƒ(x₁^{D},x₂^{A})−ƒ(x₁^{A},x₂^{A})], E₂₁ may be defined as [f(x₁^{D},x₂^{D})−ƒ(x₁^{D},x₂^{A})], and E₂₂ may be defined as [ƒ(x₁^{A},x₂^{D})−ƒ(x₁^{A},x₂^{A})].

FIG. 7 illustrates the terms in this expression in a feature space 700. As in FIG. 6, a point 706 x^{D}, is considered with several examples reference points: reference point 708 x^{A}, extrapolation point 708 and extrapolation point 710 in feature space 700. The feature space 700 is divided into an accept region 704 and a decline region 702. Differences 714 between extrapolation points and other points are labeled in connection with the expression of E₁₁, E₁₂, E₂₁, and E₂₂ previously defined.

Further, E₁₁ may measure the difference when x₁ changes from its level at the declined point 706 to its level at the declined point 712, with x₂ fixed at the declined point. Similarly, E₁₂ may measure the difference with x₂ fixed at the declined point. Note that computing the per-candidate feature contribution scores only requires computing function values at the four corners depicted in FIG. 7.

As such, it may the per-candidate feature contribution score for the x₁ and x₂ candidate features to the model may be the average of the two values as:

$${E}_{1} = \frac{1}{2} ( {E}_{11} + {E}_{12} ) \\ and \\ {E}_{2} = \frac{1}{2} ( {E}_{21} + {E}_{22} )$$

Returning now to the two-factor linear model with simple interactions actions (e.g., ƒ(x)=b₀+b₁x₁+b₂x₂+b₁₂x₁x₂), by defining E₁ and E₂ as shown above, the interaction term may be expressed as:

$${b}_{12} ( {x}_{1}^{D} {x}_{2}^{D} - {x}_{1}^{A} {x}_{2}^{A} ) = \frac{1}{2} [ {b}_{12} ( {x}_{1}^{D} {x}_{2}^{D} - {x}_{1}^{A} {x}_{2}^{D} ) + {b}_{12} ( {x}_{1}^{D} {x}_{2}^{A} - {x}_{1}^{A} {x}_{2}^{A} ) ] + \frac{1}{2} [ {b}_{12} ( {x}_{1}^{D} {x}_{2}^{D} - {x}_{1}^{D} {x}_{2}^{A} ) + {b}_{12} ( {x}_{1}^{A} {x}_{2}^{D} - {x}_{1}^{A} {x}_{2}^{A} ) ] .$$

This may be further simplified to yield

$${b}_{12} ( {x}_{1}^{D} {x}_{2}^{D} - {x}_{1}^{A} {x}_{2}^{A} ) = [ {b}_{12} ( {x}_{1}^{D} - {x}_{1}^{A} ) \frac{{x}_{2}^{D} + {x}_{2}^{A}}{2} ] + [ {b}_{12} ( {x}_{2}^{D} - {x}_{2}^{A} ) \frac{{x}_{1}^{D} + {x}_{1}^{A}}{2} ] .$$

Thus, the two-factor linear model may have the per-candidate feature contribution scores as:

$${E}_{1} = {b}_{1} ( {x}_{1}^{D} - {x}_{1}^{A} ) + \frac{1}{2} {b}_{12} ( {x}_{1}^{D} - {x}_{1}^{A} ) ( {x}_{2}^{D} + {x}_{2}^{A} ) \\ and \\ {E}_{2} = {b}_{2} ( {x}_{2}^{D} - {x}_{2}^{A} ) + \frac{1}{2} {b}_{12} ( {x}_{2}^{D} - {x}_{2}^{A} ) ( {x}_{1}^{D} + {x}_{1}^{A} ) .$$

The above results may be generalized to consider K candidate features which allows a model with K candidate features to be expressed as:

$$f ( {x}_{1} , … , {x}_{K} ) = {\sum }_{i \neq j} {f}_{ij} ( {x}_{i} , {x}_{j} ) .$$

Thus, a per-candidate feature contribution score of the k^{th} candidate feature Eₖ may be decomposed as follows:

$${E}_{k} = {\sum }_{j \neq k} \frac{1}{2} \{ [ {f}_{kj} ( {x}_{k}^{D} , {x}_{j}^{D} ) - {f}_{kj} ( {x}_{k}^{A} , {x}_{j}^{D} ) ] + [ {f}_{kj} ( {x}_{k}^{D} , {x}_{j}^{A} ) - {f}_{kj} ( {x}_{k}^{A} , {x}_{j}^{A} ) ] \} .$$

To compute the decompositions, a total of (K choose 2)*4 function evaluations are required. In particular K choose 2 sub-models of two-factors are performed and each require four evaluations.

At operation 504, the predictive data analysis computing entity 115 includes means, such as processing element 205, or the like, for evaluating, using a Baseline-Shapley decomposition function, the per-candidate feature contribution score based on the set of extrapolation feature sub-scores, and entity feature sub-scores, and reference feature sub-scores. The extrapolation scores may be identified with the extrapolation point 708 and extrapolation point 710 in feature space 700 from FIG. 7, described above. For example, the terms of the form ƒₖⱼ(xₖ^{A},xⱼ^{D}) may be identified as extrapolation feature scores. As shown, the extrapolation feature scores depend on the reference entities and the entity.

In some embodiments, the predictive analysis machine learning model may be configured to determine a pairwise feature correlation score for each pair of candidate features. A pair of candidate features may include two or more candidate features that are selected from the set of candidate features. In an instance the pairwise feature correlation score for a pair of candidate features satisfies one or more feature correlation thresholds, the predictive analysis machine learning model may determine the per-candidate feature contribution score for the candidate features together. For example, if candidate features 1 and 5, candidate features 1 and 7, and candidate features 5 and 7 are determined to each have a pairwise feature correlation score which satisfies the one or more feature correlation thresholds, candidate features 1, 5, and 7 may be considered together when determining the per-candidate feature contribution score.

The previous example of FIG. 7 may be extended to higher dimensions in an intuitive manner. For the general case of an arbitrary model with K candidate features, a special case of the Shapley decomposition, in particularly the Baseline Shapley (or B-Shap) decomposition may be applied. For a cooperative game where the goal is to distribute gains from the game among players, let K={1, 2, . . . , K} be the players of the game, {k} is the player of interest, K\k denotes the subset that does not include {k}, S is any subset of K, |S| is the cardinality of S, and val(S) is a value function associated with S. The Shapley decomposition shows that a unique distribution scheme that satisfies several desirable axioms is:

$${ϕ}_{k} = {\sum }_{S ⊆ K \backslash k} \frac{\vert S \vert ! ( \vert K \vert - \vert S \vert - 1 ) !}{\vert K \vert !} ( cal ( S ⋃ 0 k ) - val ( S ) )$$

for k=1, . . . , K. The summation is performed over all possible subsets, S, and the combinatorial coefficients arise from the number of such subsets.

The Shapley decomposition may be applied to the problem of decomposing the fitted model prediction ƒ(x*) into contributions of the K variables by specifying a particular value function. Applying B-Shap in particular, with Sₖ=S\{k}, the subset of S without {k}, a reference feature sub-score for the k^{th} candidate feature may be written as:

$${E}_{k} = {\sum }_{{S}_{k} ⊆ K \{ k \}} \frac{\vert S \vert ! ( \vert K \vert - \vert {S}_{k} \vert ) !}{\vert K \vert !} ( f ( {x}_{k}^{D} ; {x}_{{S}_{k}}^{D} ; {x}_{K \backslash S}^{A} ) - f ( {x}_{k}^{A} ; {x}_{{S}_{k}}^{D} ; {x}_{K \backslash S}^{A} ) ) .$$

The B-Shap decomposition involves only function evaluations (e.g., no integration is needed) so it is computationally more efficient than alternative models. A model with K candidate features may involve at most 2^{K} function evaluations.

Returning to FIG. 4, at operation 414, the predictive data analysis computing entity 115 may include means, such as processing element 205, or the like, for generating a set of proposed actions. The set of proposed actions, when applied to the entity, may cause the entity score to satisfy the decision threshold. In some embodiments, the predictive contribution report is further based on the set of proposed actions. The set of proposed actions may be based on the per-candidate feature contribution scores and may also be based on any other information included in the predictive contribution report data object. For example, per-candidate feature contribution scores may indicate that the most significant candidate feature that determines a customer's credit rejection is the quantity “total debt standardized.” The set of proposed actions may indicate that reducing the value of total debt standardized by a certain amount, followed by smaller reduction of other smaller contributions, such as the average monthly standardized debt, will result in the entity score changing such that a credit application is approved. The set of proposed actions may take into consideration correlations between various candidate features, for example, when total standardized debt is reduced, the average monthly debt will typically also be reduced, and the set of proposed actions may be adjusted accordingly to find a minimal explainable set of actions for creating the conditions for credit approval.

At operation 416, the predictive data analysis computing entity 115 includes means, such as processing element 205, or the like, for generating a predictive contribution report. In some embodiments, the predictive contribution report is configured to describe each candidate feature which does not satisfy one or more contribution thresholds. In some embodiments, a contribution threshold may be an absolute numerical value to which each per-candidate feature contribution score may be compared. For example, a contribution threshold of 0.600 may be indicative to include candidate features associated with the per-candidate feature contribution scores above 0.600. In some embodiments, a contribution threshold may be a percentage value to which each per-candidate feature contribution score may be compared. For example, a contribution threshold of 15% may be indicative to include the candidate features associated with the at least 15% of the sum of the value of aggregated per-candidate feature contribution scores. In some embodiments, a contribution threshold may be a value indicative of a count of candidate features to select. For example, a contribution threshold of 5 may be indicative to include the top 5 candidate features associated with the relatively largest per-candidate feature contribution scores as compared to the other per-candidate feature contribution scores associated with the remaining candidate features.

In some embodiments, the predictive contribution report may also include one or more recommendations for the entity that may improve the overall entity score based on each per-feature contribution score. For example, if a candidate feature associated with a ‘percent card utilization’ feature is determined to correspond to a per-candidate feature contribution score which does not satisfy the one or more contribution thresholds, then a recommendation may describe a predictive action of “decrease utilization of current credit usage”. As such, the entity may be provided with recommendations of predictive actions which may improve the associated entity score.

Optionally, at operation 416, the predictive data analysis computing entity 115 includes means, such as processing element 205, communications hardware 220, or the like, for generating a preliminary risk category for the entity described by the entity input data object. In particular, the predictive data analysis computing entity 115 may be configured to generate a preliminary risk category for the entity based on the overall model response. A preliminary risk category may be indicative of an inferred risk associated with performing the requested action for the entity. A preliminary risk category may include a high-risk preliminary category, a medium-risk preliminary category, and a low-risk preliminary category, for example. By way of continuing example, the overall model response for the portfolio may be an increase in predicted value of the stock and therefore, a preliminary risk category for the portfolio may be determined to be a low preliminary risk category. As another example, an overall model response for the portfolio may be a decrease in predicted value of the stock and therefore, a preliminary risk category for the portfolio may be determined to be a high preliminary risk category.

Optionally, at operation 418, the predictive data analysis computing entity 115 includes means, such as processing element 205, communications hardware 220, or the like, for generating a real-time notification processing output based on the preliminary risk category generated for the entity. In particular, each preliminary risk category may be associated with a particular set of notification processing outputs which the predictive data analysis computing entity 115 may generate. The predictive data analysis computing entity 115 may then generate the set of notification processing outputs and provide the notification processing outputs to one or more user devices, such as a user device associated with the user, a financial institution employee, or the like and may do so in substantially real-time. The real-time notification processing output may include the predictive temporal feature impact report, including the overall model response, one or more attention header scores, one or more per-temporal feature time impact scores over each time window, one or more temporal feature sets, comparisons between one or more scores, and/or the like.

By way of continuing example, a low preliminary risk category may be associated with a set of registration processing outputs which are configured to output an explanation that a low preliminary risk category is associated with the stocks of the portfolio and further, that the value of the stocks are predicted to increase over the next 3 milliseconds. In some embodiments, the notification processing output may further be configured to execute one or more additional actions, such as buying additional stocks. As such, the notification processing output may provide the explanation of that the portfolio is low risk as well as the data included in the predictive temporal feature impact report and execute one or more purchases of stocks for the customer. The purchased stock may be selected based on user configuration settings, trading history, market rates, via the use of other models, and/or the like. The notification processing output may further be generated and/or updated to include the stock that was purchased. As such, the one or more end users may receive the real-time notification processing output and may obtain an up-to-date and accurate picture of the current state of their portfolio (e.g., that the value is increasing) and may further allow the predictive data analysis computing entity 115 to take additional actions in substantially real-time based on the up-to-date model response and preliminary risk category.

As another example, a high preliminary risk category may be associated with a set of registration processing outputs which are configured to output an explanation that a high preliminary risk category is associated with the stocks of the portfolio and further, that the value of the stocks are predicted to decrease over the next 3 milliseconds. Because a high preliminary risk category was determined, the predictive data analysis computing entity 115 may determine to not buy any additional stock. As such, the notification processing output may provide the explanation of that the portfolio is high risk as well as the data included in the predictive temporal feature impact report and may also indicate that no additional stocks were purchased. As such, the one or more end users may receive the real-time notification processing output and may obtain an up-to-date and accurate picture of the current state of their portfolio (e.g., that the value is decreasing) and may be informed that no additional actions were performed due to the up-to-date model response and preliminary risk category. Additionally, the one or more end users may view the top contributing features as to why their portfolio is decreasing and thus, may be better informed as to that particular model response was determined, thereby improving model interpretability.

FIG. 4 illustrates operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an example embodiment and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations above may be modified or further amplified. Furthermore, in some embodiments, additional optional operations may be included. Modifications, amplifications, or additions to the operations above may be performed in any order and in any combination.

### VI. EXAMPLES

### Example 1

An illustrative example implementation is provided to demonstrate the results of some embodiments disclosed herein. Historical information on 50,000 customers was simulated from a financial institution for a comparable credit product. The response was binary with y equal to 1 if the account defaulted within an 18-month period and y equal to 0 otherwise. Subject matter expertise suggested that the relationship between an entity score and six of the ten candidate features should be monotone.

TABLE 1
Description of Candidate feature

| | | Monotone in entity |
|---|---|---|
| Candidate feature | Description | score |
| x₁ avg bal cards std. | Average monthly debt standardized: amount | No |
| | owed by applicant) on all of their credit cards | |
| | over last 12 months | |
| x₂ credit age std flip | Age in months of first credit product | Yes = decreasing |
| | standardized: first credit cards, auto-loans, or | |
| | mortgage obtained by the applicant | |
| x₃ pct over 50 uti | Percentage of open credit products (accounts) | No |
| | with over 50% utilization | |
| x₄ tot balance std | Total debt standardized: amount owed by | No |
| | applicant on all of their credit products (credit | |
| | cards, auto-loans, mortgages, etc.) | |
| x₅ uti open card | Percentage of open credit cards with over | No |
| | 50% utilization | |
| x₆ num acc 30 d past due | Number of non-mortgage credit-product | Yes = increasing |
| 12 mo | accounts by the applicants that are 30 or more | |
| | days delinquent within last 12 months | |
| | (Delinquent means minimum monthly | |
| | payment not made) | |
| x₇ num acc 60 d past due | Number of non-mortgage credit-product | Yes = increasing |
| 6 mo | accounts by the applicants that are 30 or more | |
| | days delinquent within last 6 months | |
| x₈ tot amt curr past due | Total debt standardized: amount owed by | Yes = increasing |
| std | applicant on all of their credit products - | |
| | credit cards, auto-loans, mortgages, etc. | |
| x₉ num credit inq 12 mo | Number of credit inquiries in last 12 months. | Yes = increasing |
| | An inquiry occurs when the applicant's credit | |
| | history is requested by a lender from the | |
| | credit bureau. This occurs when a consumer | |
| | applies for credit. | |
| x₁₀ num credit inq 24 mo | Number of credit card inquiries in last 24 | Yes = increasing |
| | months. An inquiry occurs when the | |
| | applicant's credit history is requested by a | |
| | lender from the credit bureau. This occurs | |
| | when a consumer applies for credit. | |

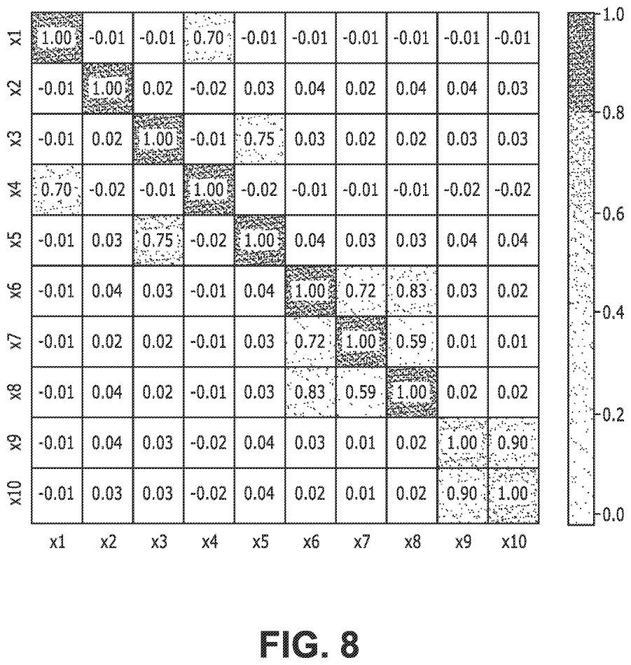

FIG. 8 shows the correlation structure of the candidate features. The z-axis of the plot (shown as a greyscale with darker shading close to 1 and lighter shading close to 0) indicates the strength of correlation (e.g., with a value of 1 being perfectly correlation and a value of 0 being no correlation) between candidate features shown along the x- and y-axes. A strong correlation structure is seen among subsets of candidate features. This may be because x₁ and x₄ are both measures of balance, x₃ and x₅ are both measures of utilization, x₆, x₇, and x₈ are measures of delinquency (e.g., past due), and x₉ and x₁₀ are both measures of number of inquiries.

Two different predictive analysis machine learning models were used to fit the above data. A first predictive analysis machine learning model employed an unconstrained feedforward neural network and a second predictive analysis machine learning model employed a monotone neural network that incorporates the shape constraints shown in table 1 to generate entity scores.

The data set of 50,000 observation was divided as follows: 80% training, 10% validation, and 10% testing. The hyperparameters of the first predictive analysis machine learning model with a FFNN algorithm was tuned and ended up with three layers and nodes and a learning rate of 0.004. The second predictive analysis machine learning model with the mono-NN had three layers with nodes and a learning rate of 0.001.

Table 2 below shows the predictive performances for the two models. The second predictive analysis machine learning model with the mono-NN has a lower training area under the receiver operating characteristic curve (AUC) but higher test AUC, indicating it generalizes to the test dataset better. It also exhibited a smaller gap between training and test AUCs, suggesting it may be more robust.

TABLE 2
Training and test AUCs

| Algorithm | Training AUC | Test AUC |
|---|---|---|
| FFNN | 0.810 | 0.787 |
| Mono-NN | 0.807 | 0.797 |

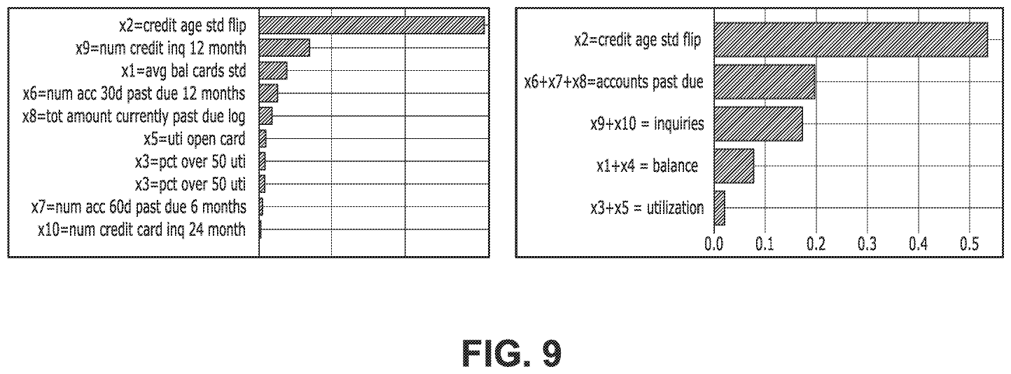

FIG. 9 plots the variable importance of the candidate features for the second predictive analysis machine learning model with the mono-NN algorithm. The leftmost plot shows the per-candidate feature contribution score for all 10 candidate features. As depicted in the plot, x₂ is shown to be the most important candidate feature followed by x₉.

It will be noted that x₁₀ is least important. This may be due to a high correlation between x₉ and x₁₀. Similarly, x₆, x₇, and x₈ may also be highly correlated such that the effects are distributed. To address possible interpretation problems from high levels of correlation, the 10 candidate features may be collapsed to get five candidate features that measure intrinsically different quantities. The right plot in FIG. 9 shows the collapsed highly correlated candidate features.

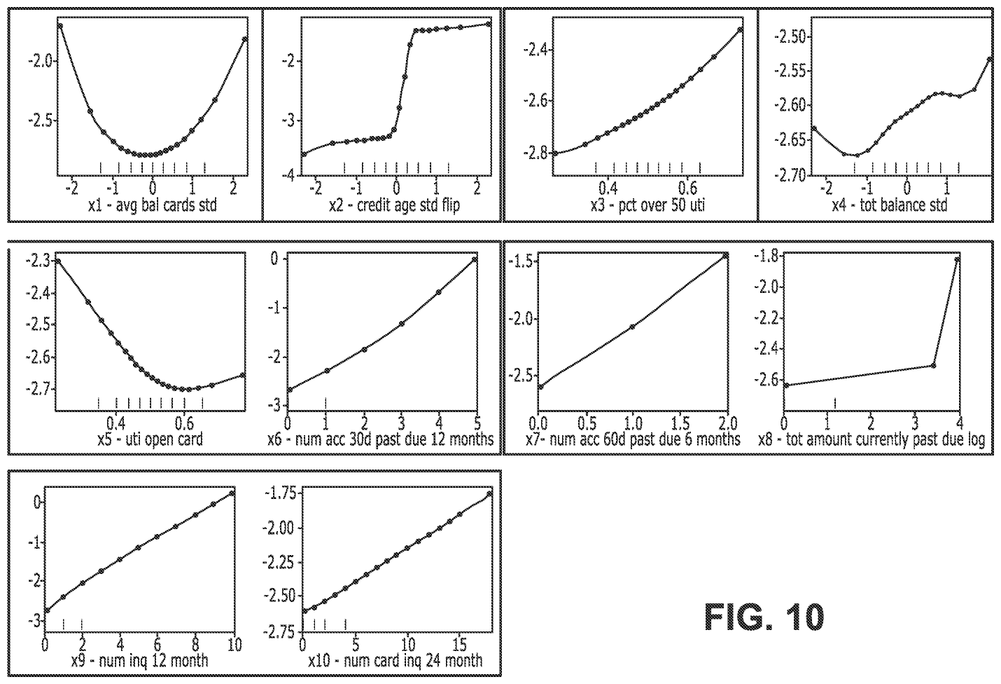

FIG. 10 depicts partial dependence plots (PDPs) for the candidate features depicting one-dimensional input-output relationships. The x-axis corresponds to the values of the candidate features and the y-axis corresponds to the log-odds of the corresponding entity score. Referring back to table 1, the second predictive analysis machine learning model with the mono-NN algorithm was constrained to be monotone in the candidate features x₂ and x₆ through x₁₀ and thus the PDPs retain this shape constraint. The candidate features x₇, x₉, and x₁₀ are mostly linear. In addition, the shape of candidate feature x₃ is also monotone. The candidate features x₁ and x₅ have quadratic behavior while x₄ has a more complex pattern.

### Example 2

Another illustrative example implementation is provided to demonstrate the results of some embodiments disclosed herein. The simulated dataset described in table 1 that mimics applications for credit cards is analyzed. The candidate features and their marginal distributions are obtained from credit bureaus data. Their correlations as well as input-output model are simulated, but mimic real-world behavior. An adverse action explanation is provided based on the predictive contribution report generated by an example method. In this example, the determination decision threshold is set to τ=0.25. The reference feature score x^{A} is selected as the 75^{th} percentile of each candidate feature, shown in Table 3 below. The corresponding reference entity score is p(x^{A})=0.016. Two entity feature scores are selected in the declined region: x₁^{D} and x₂^{D} with p(x₁^{D})=0.294 and p(x₂^{D})=0.858. The per-candidate feature contribution scores may be positive or negative for monotone increasing or decreasing variables.

TABLE 3
Results of an example implementation using a simulated
dataset that mimics applications for credit cards.

| | | | Per-candidate | | | Per-candidate | |
|---|---|---|---|---|---|---|---|
| | | | feature | | | feature | |
| Candidate | | | contribution | | | contribution | |
| feature | x^{A} | x₁^{D} | score 1 | | x₂^{D} | score 2 | |
| x₁ avg bal | −0.006 | 0.674 | 0.112 | (3.5%) | 0.519 | 0.028 | (0.5%) |
| cards std. | | | | | | | |
| x₂ credit age | −0.733 | 0.886 | 1.928 | (59.5%) | 0.431 | 1.565 | (26.5%) |
| std flip | | | | | | | |
| x₃ pct over 50 | 0.518 | 0.531 | 0.001 | (0.0%) | 0.522 | −0.001 | (0.0%) |
| uti | | | | | | | |
| x₄ tot balance | −0.001 | 0.562 | −0.008 | (0.2%) | 1.968 | −0.201 | (3.4%) |
| std | | | | | | | |
| x₅ uti open | 0.501 | 0.577 | 0.012 | (0.4%) | 0.525 | −0.024 | (0.4%) |
| card | | | | | | | |
| x₆ num acc 30 d | 0.000 | 0.000 | 0.0 | (0.0%) | 4.000 | 1.850 | (31.3%) |
| past due 12 mo | | | | | | | |
| x₇ num acc 60 d | 0.000 | 0.000 | 0.0 | (0.0%) | 2.000 | 0.984 | (16.6%) |
| past due 6 mo | | | | | | | |
| x₈ tot amt curr | 0.000 | 0.000 | 0.0 | (0.0%) | 4.379 | 1.712 | (28.9%) |
| past due std | | | | | | | |
| x₉ num credit | 0.000 | 3.000 | 1.010 | (31.2%) | 0.000 | 0.0 | (0.0%) |
| inq 12 mo | | | | | | | |
| x₁₀ num credit | 0.000 | 4.000 | 0.186 | (5.7%) | 0.000 | 0.0 | (0.0%) |
| inq 24 mo | | | | | | | |
| p(x) | 0.016 | 0.294 | | | 0.858 | | |
| f(x) = logit(p(x)) | −4.117 | −0.876 | | | 1.797 | | |

At the fourth column of Table 3, there is no difference in the values of x₆, x₇, and x₈ between x^{A} and x₁^{D}, so they do not contribute, as reflected in their corresponding per-candidate feature contribution scores. The values of x₃ and x₅ are not very different, so the contributions are correspondingly small. The values of x₁ are quite different for the entity (declined) and reference entity (accepted) points, but the contributions are relatively small due to the lesser importance of these features to the model. On the other hand, the values of x₂ in the first and third columns are quite different, and the feature is important to the model, so the corresponding per-candidate feature contribution score is large, amounting to roughly 60%.

In some embodiments, certain highly correlated candidate features may be combined in accordance with some example embodiments described previously. For example, the candidate features in the previous example show many such large correlations, and may be combined into the set of joint candidate features depicted below in Table 4. These five joint candidate features are more interpretable in terms of measuring distinct underlying measures of creditworthiness, and cause results that are easier to explain.

TABLE 4

| | Per-candidate feature | | Per-candidate feature | |
|---|---|---|---|---|
| Joint candidate feature | contribution score 1 | | contribution score 2 | |
| Balance | 0.126 | (3.9%) | −0.328 | (5.5%) |
| Credit age std flip | 1.925 | (59.4%) | 1.785 | (30.2%) |
| Utilization | 0.018 | (0.5%) | −0.018 | (0.3%) |
| Num acc | 0.0 | (0.0%) | 4.476 | (75.7%) |
| Num inq | 1.173 | (36.2%) | 0.0 | (0.0%) |

### CONCLUSION

As described above, the example embodiments provide systems, methods, and apparatuses which enable improved interpretability of determinations, evaluations, outcomes, or the like where machine learning is used. As such, improved clarity of the various factors that contributed to an outcome and the respective impact said factor had on the outcome may be discerned and provided to one or more end users to enable improved visibility, interpretability, and clarity of the machine learning model. As these measures and metrics may allow end users, such as applicants for a credit application, lenders, government regulatory body employees, etc. to learn what factors led to an application denial and the impact of each factor. Thus, credit applicants may take corrective measures to improve in these particular areas and improve the likelihood of a credit application approval on a next attempt. Additionally, the interpretability and insight provided by the predictive analysis machine learning model may conform with regulatory and/or government requirements such that the predictive analysis machine learning model may be used solely or in tandem with manual review to process credit applications.

In particular, the predictive analysis machine learning model configured to generate an entity score as well as a predictive contribution report based on each per-candidate feature contribution score for each candidate feature for an entity. Each candidate feature may be descriptive of a considered parameter used in the predictive analysis machine learning model and its impact to the entity score. Thus, the predictive analysis machine learning model may provide for an accurate entity score determination while also providing for interpretability of the impact of each candidate feature considered by said model.

Various embodiments disclosed herein also address technical challenges for efficient per-candidate feature contribution score determinations in real-time by introducing techniques that enable utilizing an existing reference entity selected based on one or more dynamically customizable reference determination decision thresholds, in part to determine the per-candidate feature contribution score for each candidate feature. By using an existing reference entity, with a reference entity score which may satisfy the one or more reference determination decision thresholds, the predictive analysis machine learning model may reduce the computational complexity of runtime operations that may be associated with processing of a non-existent reference entity for use by the predictive analysis machine learning model. Additionally, the one or more dynamically customizable reference determination decision thresholds may be customized to user, institution, regulatory body, etc. specifications, thereby allowing for controllability with respect to determination of each per-candidate feature contribution score. For example, in some embodiments, it may be advantageous to select a reference determination decision threshold such that a reference entity with reference entity score near a maximum reference entity score is selected. Alternatively, in some embodiments, it may be advantageous to select a reference determination decision threshold such that a reference entity with reference entity score near the value of the determination decision threshold is selected. In yet another embodiment, it may be advantageous to select a reference determination decision threshold near the value of the determination decision threshold but with an additional buffer score (e.g., a reference entity score 10%-15% above the determination decision threshold value) is selected.

Many modifications and other embodiments of the innovations set forth herein will come to mind to one skilled in the art to which these innovations pertain having the benefit of the teachings presented in the foregoing descriptions and the associated drawings. Therefore, it is to be understood that the innovations are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A computer-implemented method for generating a predictive contribution report for an entity using a predictive analysis machine learning model, the computer-implemented method comprising:
generating, by a predictive data analysis engine and using the predictive analysis machine learning model, an entity score for the entity, wherein the entity comprises a plurality of candidate features;
in response to the entity score failing to satisfy a determination decision threshold, selecting, by a contribution determination engine and using the predictive analysis machine learning model, a reference entity from a plurality of candidate reference entities, wherein a reference entity score associated with the reference entity satisfies the determination decision threshold;
determining, by the contribution determination engine and using the predictive analysis machine learning model, a plurality of per-candidate feature contribution scores based on the reference entity, wherein each per-candidate feature contribution score corresponds to a candidate feature in the plurality of candidate features; and
generating, by the contribution determination engine, the predictive contribution report based at least in part on the plurality of per-candidate feature contribution scores, wherein the predictive contribution report comprises one or more candidate features from the plurality of candidate features that are determined to be associated with relatively largest per-candidate feature contribution scores of the plurality of per-candidate feature contribution scores and an indication that the entity score does not satisfy the determination decision threshold.

2. The computer-implemented method of claim 1, the computer-implemented method further comprising:
determining, by the contribution determination engine and using the predictive analysis machine learning model, a pairwise feature correlation score for a pair of candidate features, wherein the pair of candidate features comprises two or more candidate features from the plurality of candidate features,
wherein a single per-candidate feature contribution score is determined for the two or more candidate features comprising the pair of candidate features in an instance in which the pairwise feature correlation score is determined to satisfy a feature correlation threshold.

3. The computer-implemented method of claim 1, the computer-implemented method further comprising:
determining, by the predictive data analysis engine, the determination decision threshold based at least in part on an analysis of aggregated historical entity data.

4. The computer-implemented method of claim 1, wherein the reference entity is selected based on minimizing a difference between the reference entity score and the determination decision threshold.

5. The computer-implemented method of claim 1, wherein the reference entity is selected by choosing the reference entity associated with a greatest reference entity score from the plurality of candidate reference entities.

6. The computer-implemented method of claim 1, wherein selecting the reference entity comprises:
generating, by the contribution determination engine, a lower-dimensional subspace comprising one or more entity feature sub-scores, wherein the lower-dimensional subspace comprises fewer dimensions than an original feature space comprising the entity;
determining, by the contribution determination engine, a candidate reference entity associated with a shortest distance to the entity out of the plurality of candidate reference entities; and
selecting, by the contribution determination engine, the candidate reference entity which has the shortest distance to the entity as the reference entity.

7. The computer-implemented method of claim 1, wherein the predictive contribution report further comprises one or more per-candidate feature contribution scores which satisfy one or more contribution thresholds.

8. The computer-implemented method of claim 1, wherein determining a per-candidate feature contribution score comprises:
evaluating, by the contribution determination engine and using the predictive analysis machine learning model, a set of extrapolation feature scores based on the reference entity and the entity; and
evaluating, by the contribution determination engine and using a Baseline-Shapley decomposition function, the per-candidate feature contribution score based on the set of extrapolation feature scores, the reference entity, and the entity score.

9. The computer-implemented method of claim 1, further comprising:
generating, by the contribution determination engine, a set of proposed actions, wherein the set of proposed actions, when applied to the entity, cause the entity score to satisfy the determination decision threshold,
wherein the predictive contribution report further comprises the set of proposed actions.

10. An apparatus for generating a predictive contribution report for an entity using a predictive analysis machine learning model, the apparatus comprising a processor, a memory storing software instructions, and:
a predictive data analysis engine configured to generate, using the predictive analysis machine learning model, an entity score for the entity, wherein the entity comprises a plurality of candidate features; and
a contribution determination engine configured to:
in response to the entity score failing to satisfy a determination decision threshold, select, using the predictive analysis machine learning model, a reference entity from a plurality of candidate reference entities, wherein a reference entity score associated with the reference entity is determined to satisfy the determination decision threshold,
determine, using the predictive analysis machine learning model, a plurality of per-candidate feature contribution scores based on the reference entity, wherein each per-candidate feature contribution score corresponds to a candidate feature in the plurality of candidate features, and
generate the predictive contribution report based at least in part on the plurality of per-candidate feature contribution scores, wherein the predictive contribution report comprises one or more candidate features from the plurality of candidate features that are determined to be associated with relatively largest per-candidate feature contribution scores of the plurality of per-candidate feature contribution scores and an indication that the entity score does not satisfy the determination decision threshold.

11. The apparatus of claim 10, wherein:
the contribution determination engine is further configured to determine, using the predictive analysis machine learning model, a pairwise feature correlation score for a pair of candidate features, wherein the pair of candidate features comprises two or more candidate features from the plurality of candidate features;
wherein a single per-candidate feature contribution score is determined for the two or more candidate features comprising the pair of candidate features in an instance in which the pairwise feature correlation score is determined to satisfy a feature correlation threshold.

12. The apparatus of claim 10, wherein the predictive data analysis engine is further configured to determine the determination decision threshold based at least in part on aggregated historical entity data.

13. The apparatus of claim 10, wherein the reference entity is selected based on minimizing a difference between the reference entity score and the determination decision threshold.

14. The apparatus of claim 10, wherein the reference entity is selected by choosing the reference entity associated with a greatest reference entity score from the plurality of candidate reference entities.

15. The apparatus of claim 10, wherein the contribution determination engine is further configured to select the reference entity by:
generating a lower-dimensional subspace comprising one or more entity feature sub-scores wherein the lower-dimensional subspace comprises fewer dimensions than an original feature space comprising the entity;
determining a candidate reference entity associated with a shortest distance to the entity out of the plurality of candidate reference entities; and
selecting the candidate reference entity which has the shortest distance to the entity as the reference entity.

16. The apparatus of claim 10, wherein the predictive contribution report comprises one or more per-candidate feature contribution scores which satisfy one or more contribution thresholds.

17. The apparatus of claim 10, wherein the contribution determination engine is further configured to determine a per-candidate feature contribution score by:
evaluating, using the predictive analysis machine learning model, a set of extrapolation feature scores based on the reference entity and the entity; and
evaluating, using a Baseline-Shapley decomposition function, the per-candidate feature contribution score based on the set of extrapolation feature scores, the reference entity, and the entity.

18. The apparatus of claim 10, wherein the contribution determination engine is further configured to generate a set of proposed actions, wherein the set of proposed actions, when applied to the entity, cause the entity score to satisfy the determination decision threshold;
wherein the predictive contribution report is further based on the set of proposed actions.

19. A computer program product for generating a predictive contribution report for an entity using a predictive analysis machine learning model, the computer program product comprising at least one non-transitory computer-readable storage medium storing software instructions that, when executed by an apparatus, cause the apparatus to:
generate, using the predictive analysis machine learning model, an entity score for the entity, wherein the entity comprises a plurality of candidate features;
in response to the entity score failing to satisfy a determination decision threshold, select, using the predictive analysis machine learning model, a reference entity from a plurality of candidate reference entities, wherein a reference entity score associated with the reference entity is determined to satisfy the determination decision threshold;
determine, using the predictive analysis machine learning model, a plurality of per-candidate feature contribution scores based on the reference entity, wherein each per-candidate feature contribution score corresponds to a candidate feature in the plurality of candidate features; and
generate the predictive contribution report based at least in part on the plurality of per-candidate feature contribution scores, wherein the predictive contribution report comprises one or more candidate features from the plurality of candidate features that are determined to be associated with relatively largest per-candidate feature contribution scores of the plurality of per-candidate feature contribution scores and an indication that the entity score does not satisfy the determination decision threshold.

20. The computer program product of claim 19, wherein the software instructions further cause the apparatus to:
determine, using the predictive analysis machine learning model, a pairwise feature correlation score for a pair of candidate features, wherein the pair of candidate features comprises two or more candidate features from the plurality of candidate features;
wherein a single per-candidate feature contribution score is determined for the two or more candidate features comprising the pair of candidate features in an instance in which the pairwise feature correlation score is determined to satisfy a feature correlation threshold.
